(19) United States
(12) Patent Application Publication
(10) Pub. No.: US 2022/0314350 A1
(43) Pub. Date: Oct. 6, 2022

(54) Method for Producing Twists on the Tooth Flanks of an Internally Toothed Workpiece

(71) Applicant: Präwema Antriebstechnik GmbH, Eschwege/Werra (DE)

(72) Inventors: Jörg Schieke, Erfurt-Marbach (DE); Walter Holderbein, Eschwege (DE); Jörg Reinhardt, Berka v.d.H. (DE)

(21) Appl. No.: 17/710,595

(22) Filed: Mar. 31, 2022

(30) Foreign Application Priority Data
Apr. 1, 2021 (DE) 10 2021 108 382.6

(51) Int. Cl. B23F 19/05

(52) U.S. Cl. CPC B23F 19/057

(57) ABSTRACT

The invention discloses a method for producing modifications, such as twists, on the tooth flanks of an internally-toothed workpiece by an externally-toothed tool. In order to carry out such a method also with machine tools, which have a reduced number of adjustable axes, the invention provides that the tool is dressed by arranging an internally-toothed dressing tool on the workpiece spindle of the machine tool at the position intended for the workpiece to be respectively honed and by bringing the dressing tool into engagement with the tool to be dressed. The width of the teeth of the dressing tool is smaller than the width of the tool to be dressed such that the dressing tool must be moved by a length along the workpiece longitudinal axis which corresponds to a multiple of the width of the teeth of the dressing tool. Subsequently, the fine machining of the workpiece takes place with the tool dressed in this manner. According to the invention, an axis cross angle is set for the dressing, which is maintained unchanged during the dressing. The respective tooth flank modification is then produced during dressing exclusively by movements of the dressing tool along the workpiece longitudinal axis and the workpiece transverse axis.

### CROSS-REFERENCE TO RELATED APPLICATION

This application claims priority to German Patent Application No. 10 2021 108 382.6 filed Apr. 1, 2021, the disclosure of which is hereby incorporated by reference in its entirety.

### BACKGROUND OF THE INVENTION

### Field of the Invention

The invention relates to a method for producing modifications on the tooth flanks of an internally-toothed workpiece by an externally-toothed tool, whose teeth come into engagement with the teeth of the workpiece during a honing process, on a machine tool, which comprises a workpiece spindle with a rotary drive for rotating the workpiece about a workpiece rotational axis, an actuating drive for adjusting the workpiece along a workpiece longitudinal axis aligned parallel to the workpiece axis, an actuating drive for adjusting the workpiece along a workpiece transverse axis, which is aligned transverse to the workpiece longitudinal axis, a tool spindle with a rotary drive for rotating the tool about a tool rotational axis as well as an actuating device for setting an axis cross angle, at which the rotational axes of workpiece and tool align in a skewed manner to one another during the honing process.

### DESCRIPTION OF RELATED ART

It is known that usage behaviour of spur wheel toothings can be largely influenced not only by their macro geometry, but also by targetedly introduced flank modifications or shape deviations occurring for process-related reasons. These shape deviations include the so-called “twists”, which are torsions of the tooth flanks.

Twists are generally not desired, but can also be targetedly introduced as flank modifications in order to compensate for the deformations of the teeth of the gear wheels occurring under load during operation. It is known that by such a modification of the flank geometry of the teeth of gear wheels, tooth engagement impacts can be avoided and the contact pattern of the toothing can be improved and thus the power transfer, the service life, the uniformity of the force transfer and the noise behaviour of gears can be optimised.

A method is known from DE 10 2012 108 717 A1 which economically enables the production of complex flank modifications of this type by means of a tool, which comprises a toothing coming into engagement with the teeth of the gear wheel during fine machining, wherein a profile is formed on the tool which profile varies over the width of the tool by moving a dressing wheel during the dressing process along the tooth flank of the tooth to be respectively dressed. The width of the teeth of the dressing wheel coming into engagement with the tool to be dressed is smaller than the width of the tool to be dressed to such an extent that the dressing wheel must be moved by a length in the Z direction to pass over the width of the tool to be dressed which corresponds to a multiple of the width of the teeth of the dressing wheel. The dressing wheel is thereby designed with a varying pitch and a varying axis cross angle with respect to the tool to be dressed in a direction (Z direction) aligned parallel to the rotational axis of the tool axially through the respective tooth gap along the respective tooth flank of the tool to be dressed in order to introduce the respective modification of the tooth flank geometry into the tool. Then, the gear wheel is fine machined with the tool dressed in this way. The flank modification worked into the tool is thus transferred to the tooth flanks of the gear wheel.

The basic principle of the use of a narrow dressing wheel, as used in the method explained above, is known from DE 10 2007 043 402 A1. By using such a narrow dressing wheel, the design of the tool to be dressed can be shaped solely by a corresponding movement of the dressing wheel such that, during the subsequent fine machining of a gear wheel with the tool dressed in this manner, profile corrections are produced on the processed gear wheel. The shape of the narrow dressing wheel must match neither in all parameters the workpiece toothing nor must complex additional control options be present in the respective dressing device. A comparable approach has been proposed in DE 10 2007 043 384 A1 for correcting the flank line of a gear wheel.

The method described in WO 2011/157830 A1 for profiling a honing tool for the honing processing of a toothing of a workpiece is also based on the use of a profiling tool with a thickness substantially smaller than the thickness of the toothing to be respectively profiled. In the case of this method, an annular, incompletely profiled honing tool is clamped in a holder of a honing machine intended for holding the honing tool during the honing processing of a workpiece and a profiling tool is clamped in the workpiece spindle of the honing machine.

### SUMMARY OF THE INVENTION

Against the background of the prior art explained above, the object has emerged to indicate a method which enables modifications, in particular twists, to be introduced into the tooth flanks of externally-toothed gear wheels even with machine tools which have a reduced number of adjustable axes.

The invention has achieved this object by the method as described herein.

Advantageous configurations of the invention are indicated in the dependent claims and, like the general concept of the invention, are explained below in detail.

In the case of a method according to the invention for producing modifications, in particular twists, on the tooth flanks of an internally-toothed workpiece by an externally-toothed honing tool, whose teeth come into engagement with the teeth of the workpiece during a honing process, a machine tool is used which comprises a workpiece spindle with a rotary drive for rotating the workpiece about a workpiece rotational axis, an actuating drive for adjusting the workpiece along a workpiece longitudinal axis Z1 aligned parallel to the workpiece rotational axis C1, an actuating drive for adjusting the workpiece along a workpiece transverse axis X1, which is aligned transverse to the workpiece longitudinal axis Z1, a tool spindle with a rotary drive for rotating the tool about a tool rotational axis E1 as well as a device for setting an axis cross angle Σ_{A}, at which the rotational axes C1, E1 of workpiece and tool are aligned in a skewed manner to one another during the honing process.

The method according to the invention thereby comprises the following work steps:
a) dressing the tool by arranging an internally-toothed dressing tool on the workpiece spindle at the position intended for the workpiece to be respectively honed and by bringing the dressing tool into engagement with the tool to be dressed, wherein the width of the teeth of the dressing tool coming into engagement with the tool to be dressed is smaller than the width of the tool to be dressed to such an extent that the dressing tool, in order to pass over the width of the tool to be dressed, must be moved by a length along the workpiece longitudinal axis which corresponds to a multiple of the width of the teeth of the dressing tool;
b) fine machining the workpiece with the tool dressed in this manner.

According to the invention, in the case of such a method, prior to carrying out work step a), the axis cross angle Σ_{A} is set.

After it has been set, this previously set axis cross-angle Σ_{A} is maintained unchanged while the dressing process of the tool is being carried out (work step a)).

The tooth flank modification, in particular twist, to be reproduced on the tool is then produced exclusively by movements of the dressing tool along the workpiece longitudinal axis (Z1) and the workpiece transverse axis (X1).

The method according to the invention therefore allows the systematic production of modifications, in particular twists, on the flanks of the teeth of an externally-toothed workpiece on a machine tool with a minimized number of movement axes.

Thus, the rotary drives are required which rotate the dressing tool and the honing tool meshing with the dressing tool at rotational speeds, which correspond to the ratio of teeth numbers of dressing tool and tool, about the respective tool rotational axis E1 and workpiece rotational axis (dresser) C1.

For the reproduction of the respective tooth flank modification, in particular twist, on the tool, in addition, only actuating drives for an adjustment of the workpiece in the longitudinal direction Z1 aligned parallel to the workpiece rotational axis C1 and in the transverse direction X1 aligned transverse thereto are required.

In contrast, a change of the axis cross angle during the processing of the tool does not take place in the method according to the invention.

Accordingly, actuating devices enabling a continuous readjusting of the axis cross angle, as has been considered as being required in the prior art explained at the outset, can be dispensed with.

It is sufficient, instead, for the method according to the invention if, prior to the dressing process, the axis cross angle suitable for the dressing process is set once. To this end, setting devices that are cost-effective to implement and known from the prior art can be provided.

The method according to the invention is suitable in the same manner for producing flank modifications, in particular twists, of straight or helical-toothed workpieces. In the case of internally-toothed workpieces and accordingly externally-toothed tools with a straight toothing, the adjustment along the workpiece transverse axis X1 that takes place in the course of the dressing process carried out according to the invention is limited to the path which is required for reproducing the twist. In the case of internally-toothed workpieces and accordingly externally-toothed tools with a straight toothing, in addition to the adjustment along the workpiece transverse axis X1 that takes place in the course of the dressing process carried out according to the invention in order to reproduce the twist, there is also an additional rotational adjustment of the dressing tool about the workpiece rotational axis C1 which is carried out for this purpose in a known manner and which is necessary to guide the narrow dressing tool along the pitch of the tool to be dressed.

In the method according to the invention, deviations on the honing tool, which are reflected in the form of shape deviations extending over the honing tool width, thus result during dressing (work step a)) by additional movements of the dresser in the direction of the workpiece transverse axis X1.

These targetedly produced deviations are transferred to the teeth of the internally-toothed workpiece during the workpiece processing subsequently carried out and are identifiable on the flanks of the teeth of the workpiece as the respectively desired tooth flank modification.

The method according to the invention is thereby suitable in particular for producing twists on the tooth flanks. The size of the twists and their geometric shape can be easily and precisely set by a corresponding specification of the axis movement along the workpiece longitudinal axis Z1 and the workpiece transverse axis X1.

If it is mentioned here that the dressing tool used according to the invention should be as narrow as possible, this means that its width is optimally reduced such that its tooth flanks assigned to the tooth flanks of the tool to be dressed are designed in the manner of a knife edge or are at least so narrow that in each case only a minimal cover surface is given between the tooth flanks of the dressing tool and the flank surfaces of the tool to be processed. Accordingly, an advantageous embodiment of the invention provides that the width of the teeth of the dressing tool coming into engagement with the honing tool to be dressed is at most one fifth, preferably at most one eighth, of the width of the tool to be dressed. Consequently, according to the invention, the tool enters, on the one workpiece front surface, the tooth gap delimited by the flank to be respectively modified and is then moved in the Z direction along the respective flank until it exits the tooth gap again at the end assigned to the other workpiece front surface.

In particular dressing tools with a width of up to 6 mm, in particular up to 4 mm, up to 2.5 mm or up to 1.2 mm, are specifically suitable for the purposes according to the invention, wherein widths of at least 0.5 mm are particularly practical in view of the stability of the dressing tool.

Like the width of the teeth of an internally-toothed gear wheel workpiece, which is measured parallel to the workpiece rotational axis, the width of a wheel-shaped dressing tool used according to the invention is measured parallel to the rotational axis of the dressing tool.

An annular, internally-toothed dressing tool, as is described in DE 10 2017 104 625 A1, is particularly suitable for carrying out the method according to the invention.

### BRIEF DESCRIPTION OF THE DRAWINGS

The invention will be explained below in more detail by means of a drawing representing an exemplary embodiment. The figures show schematically in each case:

FIG. 1 a machine tool for internal toothing honing of internally-toothed gear wheels in a frontal view;

FIG. 2 the flank surfaces of a tooth of an internally-toothed gear wheel in a perspective view;

FIG. 3a a tool for dressing or toothing an externally-toothed honing tool in frontal view;

FIG. 3b the tool according to FIG. 3a in a section along the section line A-A drawn in FIG. 3a;

FIG. 4 the movements of a dressing tool carried out in the course of the method according to the invention during the honing process.

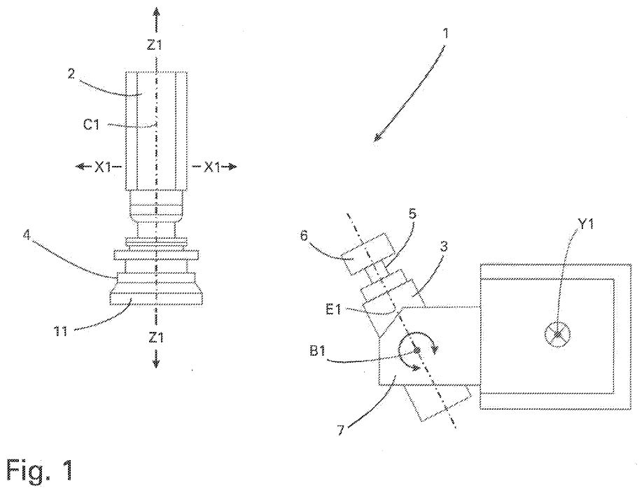

### DESCRIPTION OF THE INVENTION

Neither the spatial assignment nor the width ratios are shown correctly to scale in the figures.

The conventionally designed machine tool 1 comprises a workpiece spindle 1 and a tool spindle 3.

The workpiece spindle 2 is equipped with a receptacle 4 for the internally-toothed workpiece to be respectively processed and is coupled to a rotary drive for rotating the workpiece about a workpiece rotational axis C1, to an actuating drive for adjusting the workpiece spindle 2 along a workpiece longitudinal axis Z1 aligned parallel to the workpiece rotational axis C1 and to an actuating drive for adjusting along a workpiece transverse axis X1, which is aligned transverse to the workpiece longitudinal axis Z1.

The tool spindle 3 is equipped with a receptacle 5 for an externally-toothed tool 6 and is coupled to a rotary drive for rotating the tool 6 about a tool rotational axis E1.

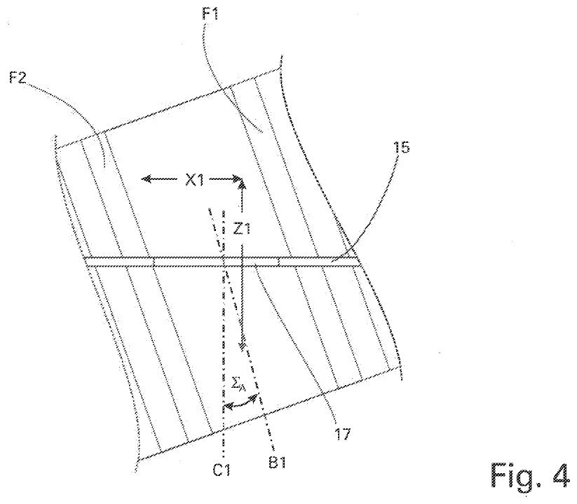

Furthermore, a device 7 is provided for setting an axis cross angle Σ_{A}, at which the workpiece rotational axis C1 and the tool rotational axis E1 are aligned in a skewed manner to one another during use such that they intersect at a projection in the drawing plane, as shown in FIG. 4. The device 7 is designed for this purpose in a known manner such that it enables a pivoting and fixing of the tool spindle 3 with respect to a pivot axis B1 which is aligned transverse to the tool rotational axis E1.

In order to enable an adjustment of the tool spindle 3 with respect to the plane spanned by the workpiece longitudinal axis Z1 and the workpiece transverse axis X1, an adjustment axis Y1 aligned normal to the concerning plane can additionally be provided, but is not required for carrying out the method according to the invention.

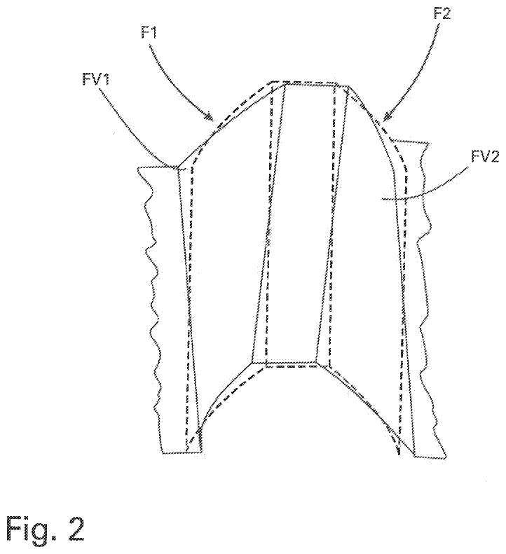

In FIG. 2, the twists to be produced on the tooth flanks F1, F2 of a tooth of an internally-toothed workpiece are shown. The surfaces surrounded with continuous lines thereby indicate the twists FV1, FV2 targetedly produced, i.e. the surface sections, in which the flank surfaces F1, F2 of the flank surfaces processed according to the invention, deviate from the design which the tooth flank surfaces F1, F2 would have if they had a standard shape free of the twists or other targetedly produced flank modifications. This standard shape of the flank surfaces F1, F2 is indicated in FIG. 2 with dashed lines.

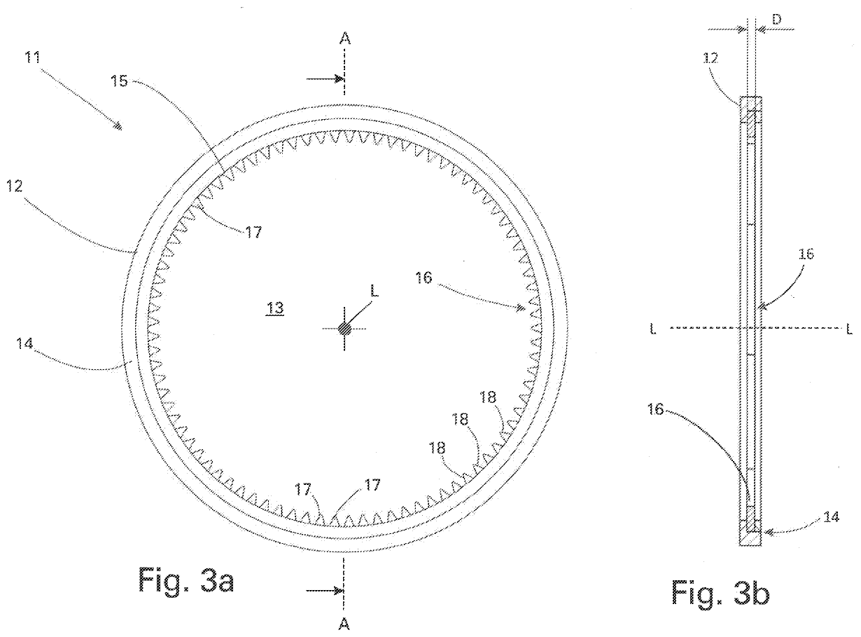

The structure of the annular dressing unit 11 represented in FIG. 3a and FIG. 3b is described in detail in DE 10 2017 104 625 A1 already mentioned above, whose content is incorporated into this application by reference. Accordingly, the dressing unit 11 comprises a support ring 12 formed from a suitable steel material, which support ring 12 circulates around a central longitudinal axis L and surrounds a support ring opening 13. The central longitudinal axis L is thereby aligned concentrically to the support ring opening 13.

Starting from the one front side 14 of the support ring 12, a circumferential shoulder is formed into the edge region assigned to the support ring opening 13. This circumferential shoulder forms a support element for a dressing tool 15, which is designed as a ring element and is therefore also referred to in practice as a “dressing wheel” and is composed of a plurality of ring segments, and which sits on the support element and at the same time abuts tightly against the inner circumferential surface of the support ring 12 facing the support element.

The dressing tool 15 has, on its inner circumference assigned to the support ring opening 13, an internal toothing 16, which is formed by teeth 17 arranged distributed at even angular spacings around the centre of the dressing tool 15. The teeth 17 of the internal toothing 16 protrude freely over the edge of the support element facing the support ring opening 13 and have, on their tooth flanks and, if applicable, also on their tooth head, in each case a cutter 18, with which they remove material during the dressing process from the honing tool 6 to be dressed.

The width D of the dressing tool 15 measured parallel to the longitudinal axis L of, for example, 3.2 mm is substantially smaller than the width of the teeth of the external toothing of the honing tool 6 to be processed. In this case, the dressing tool 15 consists, for example, of synthetic diamond, which is applied as a cutting material layer to a support layer consisting preferably of a hard metal material. The manufacture of the dressing tool 15 takes place in the manner known per se and described for example in EP 2 036 675 B1 and WO 2011/157830 A1.

For dressing the honing tool 6, the dressing unit 11 is placed with the dressing tool 15 into the receptacle of the workpiece spindle 2 in which the workpiece to be respectively processed sits during normal honing operation.

The tool rotational axis E1 and the workpiece rotational axis C1 are thereby aligned at an axis cross angle Σ_{A}, which corresponds unchanged to the axis cross angle at which the rotational axes E1 and C1 are aligned with one another during the normal honing process. If required however, an axis cross angle Σ_{A} can also be set, which deviates from the axis cross angle provided for the honing process. This can then be the case if the correspondingly deviating setting of the axis cross angle Σ_{A} provided for the dressing process contributes to producing special modifications of the shape of the tooth flanks F1, F2. What is decisive here is that the axis cross angle Σ_{A}, which has been set once, is maintained unchanged during the dressing process.

At the start of the dressing process, the dressing unit 11 rotating about the workpiece rotational axis C1 is positioned with the dressing tool 15 adjacent to the one front side of the honing tool 6 to be dressed and rotating about the tool rotational axis E1. Then, the dressing unit 11 is moved with the dressing tool 15 towards the honing tool 6 along the workpiece longitudinal axis Z1 until the teeth 17 of the dressing tool 15 engage into the tooth gaps of the honing tool 6 which is helically toothed here and dressing tool 15 and honing tool 6 begin to mesh with one another. At the same time, the dressing tool 15 is moved in the direction of the workpiece transverse axis X1.

In the course of this, the movement along the workpiece transverse axis X1 is varied such that correspondingly to the twist FV1, FV2 to be reproduced, the cutter 18 of the respective tooth 17 of the dressing tool 15 engaged with one of the teeth of the honing tool 6 removes more or less material from the tooth flank F1, F2 respectively processed.

The invention thus provides a method which allows modifications, such as twists FV1, FV2, to be produced on the tooth flanks F1, F2 of an internally-toothed workpiece by an externally-toothed tool 6 on a machine tool 1, which has a reduced number of adjustable axes. To this end, the invention provides that the tool 6 is dressed by arranging an internally-toothed dressing tool 15 on the workpiece spindle 2 of the machine tool 1 at the position intended for the workpiece to be respectively honed and by bringing the dressing tool 15 into engagement with the tool 6 to be dressed. The width of the teeth 17 of the dressing tool 15 is smaller than the width of the tool 6 to be dressed such that the dressing tool 15 must be moved by a length along the workpiece longitudinal axis Z1 which corresponds to a multiple of the width D of the teeth of the dressing tool 15. Subsequently, the fine machining of the workpiece 6 takes place with the tool 1 dressed in this manner. According to the invention, an axis cross angle Σ_{A} is set for the dressing which is maintained unchanged during the dressing. The respective tooth flank modification FV1, FV2 is then produced on the workpiece 6 during dressing exclusively by movements of the dressing tool 15 along the tool longitudinal axis Z1 and the tool transverse axis X1.

### REFERENCE NUMERALS

1 Machine tool
2 Workpiece spindle
3 Tool spindle
4 Receptacle for the internally-toothed workpiece to be processed
5 Receptacle for an externally-toothed honing tool 6
6 Honing tool
7 Device for setting an axis cross angle Σ_{A}
11 Annular dressing unit (see DE 10 2017 104 625 A1)
12 Support ring
13 Support ring opening
14 Front side of the support ring 12
15 Dressing tool
16 Internal toothing of the dressing tool 15
17 Teeth of the dressing tool 15
18 cutter of the teeth 17
B1 Pivot axis of the tool spindle 3
C1 Workpiece rotational axis
D Width of the dressing tool 15
E1 Tool rotational axis
F1, F2 Tooth flanks of a tooth of an internally-toothed workpiece
FV1, FV2 Twists
L Central longitudinal axis of the dressing unit 11
X1 Workpiece transverse axis
Y1 Adjusting axis of the tool spindle 3
Z1 Workpiece longitudinal axis
Σ_{A} Axis cross angle

1. A method for producing modifications, such as twists, on the tooth flanks of an internally-toothed workpiece by an externally-toothed tool, whose teeth come into engagement with the teeth of the workpiece during a honing process, on a machine tool which comprises a workpiece spindle with a rotary drive for rotating the workpiece about a workpiece rotational axis, an actuating drive for adjusting the workpiece along a workpiece longitudinal axis aligned parallel to the workpiece rotational axis, an actuating drive for adjusting the workpiece along a workpiece transverse axis, which is aligned transverse to the workpiece longitudinal axis, a tool spindle with a rotary drive for rotating the tool about a tool rotational axis as well as a device for setting an axis cross angle, at which the rotational axes of workpiece and tool are aligned in a skewed manner to one another during the honing process, comprising the following work steps:
a) dressing the tool by arranging an internally-toothed dressing tool on the workpiece spindle at the position intended for the workpiece to be respectively honed and by bringing the dressing tool into engagement with the tool to be dressed, wherein the width of the teeth of the dressing tool coming into engagement with the tool to be dressed is smaller than the width of the tool to be dressed to such an extent that the dressing tool, in order to pass over the width of the tool to be dressed, must be moved by a length along the workpiece longitudinal axis which corresponds to a multiple of the width of the teeth of the dressing tool;
b) fine machining the workpiece with the tool dressed in this manner,
wherein prior to carrying out work step a), the axis cross angle is set, in that, while the work step a) is being carried out, the previously set axis cross angle is maintained unchanged and in that the modification of the tooth flanks is produced exclusively by movements of the dressing tool along the workpiece longitudinal axis and the workpiece transverse axis.

2. The method according to claim 1, wherein the width of the dressing tool is at most 6 mm.

3. The method according to claim 2, wherein the width of the dressing tool is at most 2.5 mm.

4. The method according to claim 1, wherein the width of the dressing tool is at least 0.5 mm.
